(19) United States
(12) Patent Application Publication
(10) Pub. No.: US 2020/0012154 A1
(43) Pub. Date: Jan. 9, 2020

(54) BACKLIGHT AND BACKLIGHT PRODUCTION METHOD

(71) Applicant: SHARP KABUSHIKI KAISHA, Sakai City, Osaka (JP)

(72) Inventors: HISASHI WATANABE, Sakai City, Osaka (JP); HIROTOSHI YASUNAGA, Sakai City, Osaka (JP); YOUZOU KYOUKANE, Sakai City, Osaka (JP)

(21) Appl. No.: 16/494,691

(22) PCT Filed: Mar. 16, 2018
(86) PCT No.: PCT/JP2018/010624

§ 371 Date: Sep. 16, 2019

(30) Foreign Application Priority Data
Mar. 23, 2017 (JP) 2017-057542

(51) Int. Cl. G02F 1/1335

(52) U.S. Cl. CPC G02F 1/133609; G02F 1/133605; G02F 1/133603

(57) ABSTRACT

A direct backlight and a manufacturing method of a backlight that can prevent color unevenness are provided. A backlight includes a plurality of LEDs disposed immediately below a display panel and configured to emit white light, and an optical sheet-provided on an emitting surface side of the LEDs with an air layer interposed between the optical sheet and the LEDs. The optical sheet includes a print pattern. Chromaticity of emitted light of the LEDs and chromaticity of reflected light of the print pattern when an achromatic light source (x=0.333 and y=0.333 in a CIE-XYZ color system) is used as illumination light are equal to each other.

### TECHNICAL FIELD

The disclosure relates to a direct backlight and a manufacturing method of a backlight.

### BACKGROUND ART

As a display with higher picture quality, “high dynamic range imaging (HDR)” has been drawing attention. To implement HDR in a liquid crystal display device, local dimming control that locally adjusts luminance levels of a backlight is necessary. As such a backlight, direct backlights have hitherto been known, which have been adopted in television sets and the like. There has been a tendency that the thickness of direct backlights is increased, with the purpose of diffusing light of LEDs to make light of LEDs uniform.

In view of this, in a thin direct backlight disclosed in NPL 1, a reflective sheet having bored holes is provided on an upper side of LEDs.

In contrast, as another technique for implementing a thin backlight, a technique disclosed in PTL 1 has been known, for example. In a backlight disclosed in PTL 1, a reflective sheet to which white ink is applied in a dot-like manner is provided on an upper side of light sources. Further, a diameter of print dots is changed depending on a distance from the light sources, so that luminance is made uniform.

### CITATION LIST

### Patent Literature

PTL 1: JP 2005-117023 A (published on 28 Apr. 2005)

### Non Patent Literature

NPL 1: Opto Design Inc., Products “direct LED flat illumination,” [searched on 6 Mar. 2017], Internet <URL: http://www.opto-design.com/products/unibrite>

### SUMMARY

### Technical Problem

However, the known backlights have a problem of the following phenomenon. Specifically, backlights have subtle tinge variation in unit block, and such variation is observed as unevenness. For example, depending on a distance from light sources, tinge variation occurs, which is recognized as color unevenness.

The disclosure is achieved in view of the known problem described above, and has an object to provide a direct backlight and a manufacturing method of a backlight that can prevent color unevenness.

### Solution to Problem

To solve the problem described above, a backlight according to one aspect of the disclosure is a backlight including a plurality of light sources disposed immediately below a display panel and configured to emit white light, a reflective sheet provided to surround the plurality of light sources, and an optical sheet provided on an emitting surface side of the plurality of light sources with an air layer interposed between the optical sheet and the plurality of light sources. The optical sheet includes a reflective layer, and chromaticity of emitted light of the plurality of light sources and chromaticity of reflected light of the reflective layer are equal to each other.

A manufacturing method of a backlight according to one aspect of the disclosure is a manufacturing method of a backlight including a plurality of light sources disposed immediately below a display panel and emitting white light, a reflective sheet provided to surround the plurality of light sources, and an optical sheet provided on an emitting surface side of the plurality of light sources with an air layer interposed between the optical sheet and the plurality of light sources. The manufacturing method includes forming a reflective layer on the optical sheet and adjusting chromaticity of emitted light of the plurality of light sources to be equal to chromaticity of reflected light of the reflective layer.

### Advantageous Effects of Disclosure

One aspect of the disclosure produces an effect of providing a direct backlight and a manufacturing method of a backlight that can prevent color unevenness.

### BRIEF DESCRIPTION OF DRAWINGS

FIG. 1A is a plan view illustrating a configuration of an optical sheet of a backlight of a first embodiment of the disclosure. FIG. 1B is a cross-sectional view illustrating a configuration of the backlight.

FIG. 2A is a perspective view illustrating a configuration of the backlight. FIG. 2B is a cross-sectional view illustrating a configuration of the backlight. FIG. 2C is a circuit diagram illustrating a circuit of an LED substrate.

FIG. 3 is a graph illustrating a relationship between a wavelength and reflectivity concerning a print pattern of white ink in the optical sheet of the backlight.

FIG. 4A is a perspective view illustrating a configuration of a backlight of a second embodiment of the disclosure. FIG. 4B is a cross-sectional view illustrating a configuration of the backlight.

FIG. 5 is a cross-sectional view illustrating a configuration of a backlight of a third embodiment of the disclosure.

FIG. 6 is a diagram illustrating Example of the backlight of the disclosure, and illustrating a relationship between chromaticity of emitted light of light sources and chromaticity of reflected light of the print pattern when chromaticity of emitted light of the light sources is adjusted so that chromaticity of emitted light of the light sources is equal to chromaticity of reflected light of the print pattern.

FIG. 7A is a plan view illustrating the backlight of Example described above, and illustrating a state of color unevenness when an x coordinate of chromaticity of emitted light of the light sources and an x coordinate of chromaticity of reflected light of the print pattern are brought to be equal to each other. FIG. 7B is a plan view illustrating a state of color unevenness when a y coordinate of chromaticity of emitted light of the light sources and a y coordinate of chromaticity of reflected light of the print pattern are brought to be equal to each other.

FIG. 8A is a plan view illustrating a backlight of Comparative Example, and illustrating a state of color unevenness when an x coordinate of chromaticity of emitted light of light sources and an x coordinate of chromaticity of reflected light of a print pattern are different from each other. FIG. 8B is a plan view illustrating a state of color unevenness when a y coordinate of chromaticity of emitted light of light sources and a y coordinate of chromaticity of reflected light of a print pattern are different from each other.

### DESCRIPTION OF EMBODIMENTS

### First Embodiment

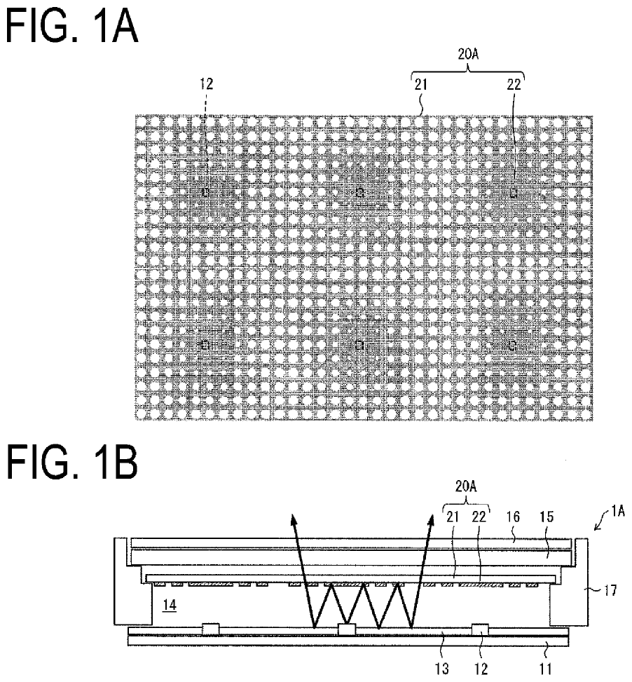

The following describes one embodiment of the disclosure with reference to FIG. 1A to FIG. 3.

A backlight of the present embodiment is applied to a local dimming backlight, i.e., a direct backlight. For example, the local dimming backlight is applied to various displays, such as a television, a PC, a mobile phone, a smartphone, a tablet, a digital camera, and a car navigation device. For example, a liquid crystal display device is preferable as a display.

### Configuration of Backlight

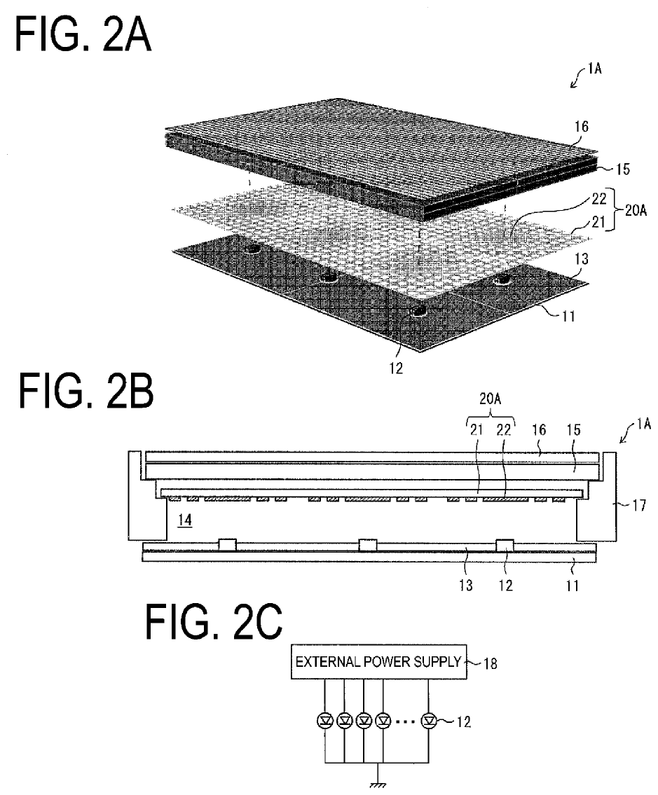

A configuration of a backlight 1A of the present embodiment will be described with reference to FIGS. 2A, 2B, and 2C. FIG. 2A is a perspective view illustrating a configuration of the backlight 1A. FIG. 2B is a cross-sectional view illustrating a configuration of the backlight 1A. FIG. 2C is a circuit diagram illustrating a circuit of an LED substrate.

The backlight 1A of the present embodiment is a direct backlight as described above. Thus, for example, a liquid crystal display panel (not illustrated) is present on an upper side of the backlight 1A.

As illustrated in FIGS. 2A, 2B, and 2C, the backlight 1A includes an LED substrate 11 on which LEDs 12 and a reflective sheet 13 are mounted. On an upper side of the LED substrate 11, an optical sheet 20A, a diffuser sheet 15, and a prism sheet 16 are layered in this order, with an air layer 14 interposed between the upper side of the LED substrate 11 and the optical sheet 20A. In the air layer 14, a frame 17 for maintaining an interval between the LED substrate 11 and the optical sheet 20A is formed. As illustrated in FIGS. 2A and 2B, the frame 17 of the present embodiment is made of a frame-shaped member that fixes each member. To prevent light leakage to the periphery and enhance luminance, it is preferable that the frame 17 be made of a material having high reflectivity, such as a white resin. One typical example of such a material is polycarbonate.

In the present embodiment, for example, six LEDs 12 are disposed inside each of frames 17 made of a frame-shaped member. Note that the number of LEDs 12 inside the frame 17 made of a frame-shaped member is not limited to six, and may be a different number.

The LED substrate 11 is a general circuit substrate made of glass epoxy or aluminum (Al), for example. The LEDs 12 are mounted at specific positions.

In the present embodiment, the LEDs 12 are configured to emit white light. As illustrated in FIG. 2C, the LEDs 12 are connected to an external power supply 18 with a cable, for example. It is preferable that the external power supply 18 be capable of controlling and applying a specific electric current to each LED 12. To enhance light use efficiency, it is preferable that a surface of the LED substrate 11 on which the LEDs 12 are mounted be coated white. One typical example of a material for white coating is a high-reflection solder resist “trade designation: PSR-4000” manufactured by TAIYO HOLDINGS CO., LTD.

The reflective sheet 13 disposed on the LED substrate 11 is disposed on the entire LED substrate 11 so as to surround the LEDs 12. White coating formed on the LED substrate 11 generally has low reflectivity. Thus, it is preferable that a reflective sheet 13 having openings at positions of the LEDs 12 be provided, as in the present embodiment. Note that the reflective sheet 13 may be omitted, on the condition that sufficient luminance can be secured with reflectivity of a material for white coating. Specific examples of a material for the reflective sheet 13 may include trade designation “ESR” manufactured by 3M Japan Limited, and Lumirror (trade name) and trade designation “E6SR” manufactured by TORAY INDUSTRIES, INC. In Example, trade designation “ESR” manufactured by 3M Japan Limited was used. Trade designation “ESR” is a reflective sheet 13 with little tinge of reflected light, and having reflectivity of nearly 100%. Even when the reflective sheet 13 is provided, a surface of the LED substrate 11 may be slightly exposed through an opening. Thus, it is desirable that the LED substrate 11 be coated white.

For example, the diffuser sheet 15 is made of a milk-white sheet, and is configured to uniformly diffuse light emitted from the LEDs 12. The diffuser sheet 15 can blur a boundary between a light reflective surface and a light transmitting surface of the optical sheet 20A, and can make light intensity uniform. When the diffuser sheet 15 is omitted, a light transmitting surface looks bright and a light reflective surface looks dark, which appears as unevenness and is thus not preferable. Specific examples of a material include trade designation “SUMIPEX OPAL SHEET” manufactured by Sumitomo Chemical Co., Ltd.

The prism sheet 16 is a general prism sheet of a backlight for luminance enhancement. One typical example is trade designation “BEF” manufactured by 3M Japan Limited. Generally, prisms having an apex angle of 90 degrees are arrayed with no gaps. In products that do not require a very wide viewing angle in the vertical and horizontal directions, such as a smartphone and a notebook PC, two prism sheets are often orthogonally layered. In this manner, screen luminance can be efficiently enhanced. By contrast, it is desirable that display devices such as a television and an on-board display device have a wide viewing angle in the horizontal direction, and do not require a very wide viewing angle in the vertical direction. Thus, one prism sheet is often mounted so that a direction of a ridge line and the horizontal direction match. In this manner, a viewing angle is widened only in the horizontal direction, and light is narrowed only in the vertical direction, so that luminance can be enhanced. In the present embodiment, one prism sheet is used.

The optical sheet 20A is a sheet including both of a light reflective surface and a light transmitting surface. At positions immediately above the LEDs 12, density of a reflective surface is high. At positions away from the LEDs 12, the area of a reflective surface is smaller, and a transmitting surface is increased. The optical sheet 20A is mounted to have a specific interval from the LEDs 12, with the air layer 14 interposed between the optical sheet 20A and the LEDs 12.

As methods of providing both of a light reflective surface and a light transmitting surface, the following two methods are given.

(1) Holes having a specific pattern are bored through a reflective sheet, such as a white sheet, a metal-deposited sheet, and a metal sheet.

(2) White ink is formed on a transparent sheet with a specific pattern, with a printing method or the like. Alternatively, a metal thin film is formed with a specific pattern, with a mask vapor deposition method or the like.

In the present embodiment, a print pattern 22 of white ink is formed with method (2).

Specifically, as illustrated in FIGS. 2A and 2B, for example, white ink to be a reflective surface was printed on a transparent sheet 21 made of transparent PET as typified by trade designation “Lumirror T60” manufactured by TORAY INDUSTRIES, INC., with screen printing. In this manner, the print pattern 22 was formed. Regarding the print pattern 22, circular uncoated portions were disposed in a grid pattern. At positions immediately above the LEDs 12, a print pattern 22 was applied in a wide range. As the white ink, trade designation “EG-671” manufactured by Teikoku Printing Inks Mfg. Co., Ltd. was used. For example, a film thickness of a reflective surface is 20 μm.

As a method of forming a reflective surface, the following methods may be used in addition to screen printing. Such methods include various printing methods such as gravure printing and inkjet printing, and a method of metal thin film vapor deposition, for example.

This allows easier manufacturing compared to method (1) of boring holes, which is a method of providing both of other reflective surfaces and transmitting surfaces. Therefore, processes are easier, and costs are reduced.

### Function of Optical Sheet

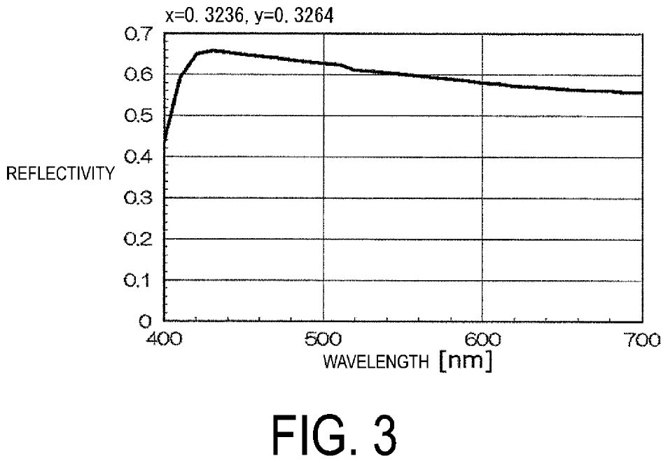

The function of the optical sheet 20A of the present embodiment will be described with reference to FIGS. 1A and 1B and FIG. 3. FIG. 1A is a plan view illustrating a configuration of the optical sheet 20A of the backlight 1A of the present embodiment. FIG. 1B is a cross-sectional view illustrating a configuration of the backlight 1A. FIG. 3 is a graph illustrating a relationship between a wavelength and reflectivity concerning a print pattern of white ink in the optical sheet 20A of the backlight 1A.

A characteristic point of the backlight 1A of the present embodiment is a configuration of making chromaticity of color of emitted light of the LEDs 12 and chromaticity of reflected color of white ink in the print pattern 22 of the optical sheet 20A equal to each other.

As illustrated in FIG. 1B, light immediately above the LEDs 12 impinges upon the print pattern 22 coated with white ink and a small portion of the light is transmitted, but most of the light is reflected toward the LED substrate 11 side. Through repetition of such reflection, light reaches positions away from the LEDs 12, and thus uniformity of luminance can be enhanced. However, when reflection characteristics of the print pattern 22 made of white ink have wavelength dependency, i.e., when reflected light has a tinge and is not pure white, the color of the reflected light is to be changed according to the number of times of reflection. As a result, color varies between positions immediately above the LEDs 12 and positions around the LEDs 12. Consequently, color unevenness is observed.

Here, generally, white ink is obtained by dispersing titanium oxide particles as its pigments, and therefore reflection characteristics of white ink are substantially determined and are hardly changed. As one example of white ink, for example, as illustrated in FIG. 3, characteristics of white ink “trade designation: EG-671” manufactured by Teikoku Printing Inks Mfg. Co., Ltd. are illustrated below. As illustrated in FIG. 3, chromaticity of reflected light of white ink “trade designation: EG-671” manufactured by Teikoku Printing Inks Mfg. Co., Ltd. is x=0.3236 and y=0.3264 in chromaticity coordinates of the CIE-XYZ color system. Note that, as an illumination light source when chromaticity of reflected light of white ink “trade designation: EG-671” manufactured by Teikoku Printing Inks Mfg. Co., Ltd. was measured, an achromatic light source (x=0.333 and y=0.333 in the CIE-XYZ color system) was used.

Here, a tinge can be adjusted through an adjustment with coloring pigments or the like. However, reflectivity is reduced for the reason that light in a redundant wavelength is absorbed by pigments for adjustment. Therefore, this is not preferable in terms of light use efficiency. Specifically, when general white ink is used, color is gradually shifted in a blue direction every time light is reflected by an ink surface. Therefore, at positions immediately above the LEDs 12 and positions around the LEDs 12, non-negligible color unevenness occurs.

In view of this, in the backlight 1A of the present embodiment, chromaticity of color of emitted light of the LEDs 12 is brought closer to chromaticity of reflected color of white ink of the print pattern 22 of the optical sheet 20A. Then, as a result of an experiment illustrated in Example to be described later, it was found that chromaticity of emitted light of the LEDs 12 preferably satisfies values of x=0.324±0.001 and y=0.326±0.001 in the CIE-XYZ color system.

In this manner, the backlight 1A of the present embodiment includes the LEDs 12 serving as a plurality of light sources disposed immediately below a display panel (not illustrated) and emitting white light, and the optical sheet 20A provided on an emitting surface side of the LEDs 12 with the air layer 14 interposed between the optical sheet 20A and the LEDs 12. The optical sheet 20A includes a reflective layer, and chromaticity of emitted light of the LEDs 12 and chromaticity of reflected light of the reflective layer are equal to each other.

Specifically, when the reflective layer of the optical sheet 20A is not pure white, the color of the reflected light is to be changed. As a result, color varies between positions immediately above the light sources and positions around the light sources. Consequently, color unevenness is observed.

In view of this, in the backlight 1A of the present embodiment, chromaticity of the emitted light of the LEDs 12 and chromaticity of reflected light of the reflective layer when an achromatic light source (x=0.333 and y=0.333 in the CIE-XYZ color system) is used as illumination light are brought to be equal to each other. Therefore, a hue of the reflected light of the reflective layer is not changed, which prevents color from gradually varying between positions immediately above the light sources and positions around the light sources. As a result, color unevenness is hardly observed.

Therefore, a direct backlight 1A that can prevent color unevenness can be provided.

Further, in the backlight 1A of the present embodiment, an adjustment is made so that the chromaticity of the emitted light of the LEDs 12 is equal to the chromaticity of the reflected light of the reflective layer. Therefore, change in hues of reflected light of the reflective layer can be reduced, and color unevenness can be reduced.

In the backlight 1A of the present embodiment, the chromaticity of the emitted light of the LEDs 12 and the chromaticity of the reflected light of the reflective layer satisfy values of x=0.324±0.001 and y=0.326±0.001 in the CIE-XYZ color system. In this manner, when chromaticity of the emitted light of the light sources and chromaticity of the reflected light of the reflective layer when an achromatic light source (x=0.333 and y=0.333 in the CIE-XYZ color system) is used as illumination light are set to be equal to each other, the direct backlight 1A that can prevent color unevenness can be provided.

In the backlight 1A of the present embodiment, the optical sheet 20A is made of the transparent sheet 21 including the print pattern 22 serving as the reflective layer on a part of a surface of the transparent sheet 21.

With this configuration, for example, when the print pattern 22 is disposed in a larger amount at positions immediately above the LEDs 12, there is more reflected light at positions immediately above the LEDs 12. When the print pattern 22 is disposed in a smaller amount at positions away from the LEDs 12, light is transmitted through the transparent sheet 21. As a result, uniformity of luminance can be enhanced in the entire optical sheet 20A.

A manufacturing method of the backlight 1A of the present embodiment is a manufacturing method of a backlight including a plurality of LEDs 12 disposed immediately below a display panel and emitting white light, and the optical sheet 20A provided on an emitting surface side of the LEDs 12 with the air layer 14 interposed between the optical sheet 20A and the LEDs 12. The manufacturing method includes the steps of forming the print pattern 22 on the optical sheet 20A, and adjusting chromaticity of emitted light of the LEDs 12 to be equal to chromaticity of reflected light of the print pattern 22 when an achromatic light source (x=0.333 and y=0.333 in the CIE-XYZ color system) is used as illumination light.

With this configuration, chromaticity of the emitted light of the LEDs 12 and chromaticity of the reflected light of the print pattern 22 when an achromatic light source (x=0.333 and y=0.333 in the CIE-XYZ color system) is used as illumination light can be easily brought to be equal to each other. Therefore, a manufacturing method of a direct backlight 1A that can prevent color unevenness can be provided.

### Second Embodiment

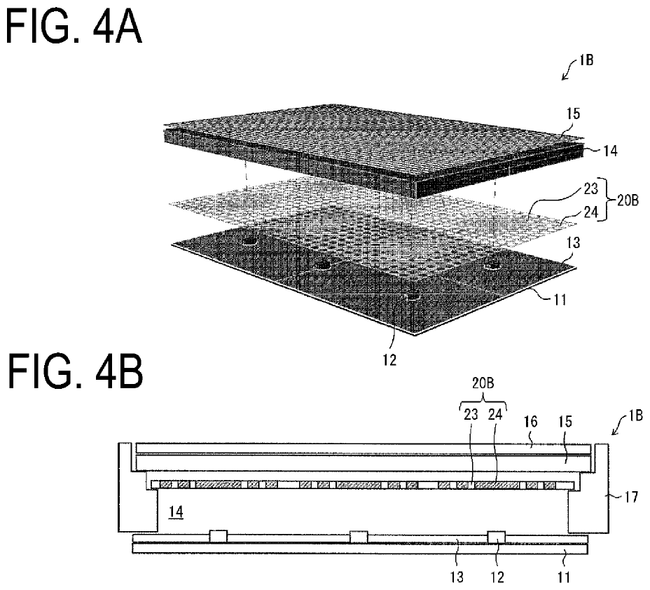

The following describes another embodiment of the disclosure with reference to FIGS. 4A and 4B. Note that configurations other than what is described in the present embodiment are the same as those of the first embodiment. For the sake of convenience of description, a member having the same function as the function of the member illustrated in the drawings of the first embodiment is denoted by the same reference sign, and description thereof is omitted.

In a backlight 1B of the present embodiment, as a method of providing both of a light reflective surface and a light transmitting surface, the example proposed in the first embodiment “(1) holes having a specific pattern are bored through a reflective sheet, such as a white sheet, a metal-deposited sheet, and a metal sheet” will be described.

A configuration of the backlight 1B of the present embodiment will be described with reference to FIGS. 4A and 4B. FIG. 4A is a perspective view illustrating a configuration of the backlight 1B of the present embodiment. FIG. 4B is a cross-sectional view illustrating a configuration of the backlight 1B.

As illustrated in FIGS. 4A and 4B, in the backlight 1B of the present embodiment, an optical sheet 20B is made of a white sheet 24 serving as a reflective layer having a plurality of bored openings 23.

For example, regarding the white sheet 24, a plurality of circular shape openings 23 were bored as holes at specific positions through white PET as typified by “trade designation: Lumirror E20” manufactured by TORAY INDUSTRIES, INC. in a grid pattern, with machining using a die. At positions immediately above the LEDs 12, the number of openings 23 was reduced. When metal vapor deposition or a metal sheet is used, highly precise holes can be bored with etching.

In the present embodiment, chromaticity of color of emitted light of the LED 12 was adjusted to be equal to chromaticity of reflected color of the white sheet 24 being a base material of the optical sheet 20B.

In this manner, in the backlight 1B of the present embodiment, the optical sheet 20B is made of the white sheet 24 serving as a reflective layer having a plurality of bored openings 23.

Also with this configuration, when chromaticity of emitted light of the LEDs 12 and chromaticity of reflected light of the white sheet 24 are set to be equal to each other, a direct backlight 1B that can prevent color unevenness can be provided.

When the number of openings 23 is reduced at positions immediately above the LEDs 12, emitted light from the LEDs 12 is reflected by the white sheet 24. When the number of openings 23 is increased in an area away from the positions immediately above the LEDs 12, light is transmitted through the openings 23. As a result, uniformity of luminance can be enhanced in the entire optical sheet 20B.

Further, in the backlight 1B of the present embodiment, the white sheet 24 serving as the reflective layer is used, and a print pattern is not used. Therefore, a labor of forming a print pattern can be omitted.

### Third Embodiment

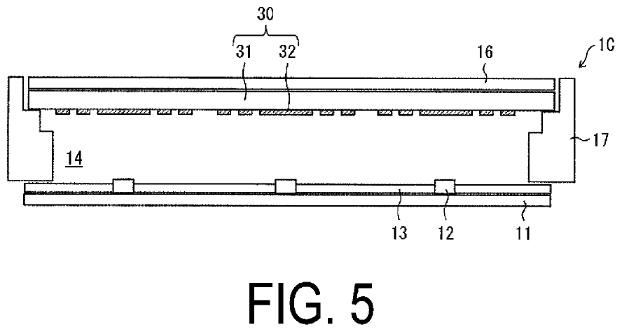

The following describes yet another embodiment of the disclosure with reference to FIG. 5. Note that configurations other than what is described in the present embodiment are the same as those of the first embodiment. For the sake of convenience of description, a member having the same function as the function of the member illustrated in the drawings of the first embodiment is denoted by the same reference sign, and description thereof is omitted.

In the backlight 1A of the first embodiment and the backlight 1B of the second embodiment, the optical sheets 20A and 20B are present, and the reflective layer is provided on the optical sheets 20A and 20B. In contrast, a backlight 1C of the present embodiment is different in that a reflective layer of one aspect of the disclosure is formed on a diffuser sheet 30.

A configuration of the backlight 1C of the present embodiment will be described with reference to FIG. 5. FIG. 5 is a cross-sectional view illustrating a configuration of the backlight 1C of the present embodiment.

As illustrated in FIG. 5, in the backlight 1C of the present embodiment, the diffuser sheet 30 includes a milk-white sheet 31, and a print pattern 32 serving as a reflective layer provided on the LED 12 side of the milk-white sheet 31.

The print pattern 32 is provided in high density at positions immediately above the LEDs 12, and is applied to have lower density as a distance from the positions immediately above the LEDs 12 increases.

Note that, in the present embodiment, the optical sheets 20A and 20B present on the backlight 1A of the first embodiment and the backlight 1B of the second embodiment may be omitted. Such a configuration is preferable in that the number of members is reduced and manufacturing can be achieved with lower costs.

In this manner, in the backlight 1C of the present embodiment, the diffuser sheet 30 serving as an optical sheet is made of a member including the print pattern 32 serving as a reflective layer on a part of a surface of the milk-white sheet 31.

Also with this configuration, when chromaticity of emitted light of the LEDs 12 and chromaticity of reflected light of the milk-white sheet 31 are set to be equal to each other, the direct backlight 1C that can prevent color unevenness can be provided.

### EXAMPLE

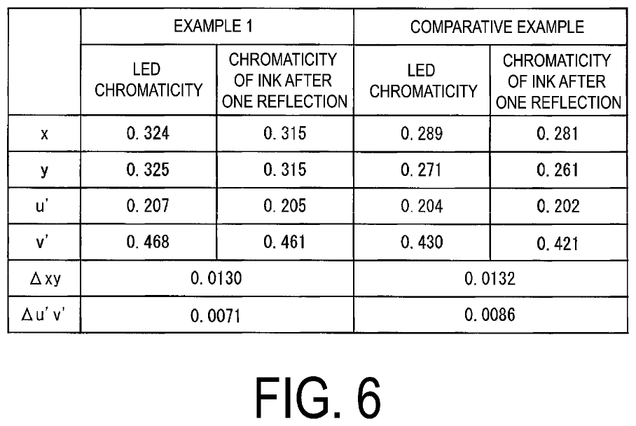

The following describes Example of the disclosure with reference to FIG. 6 to FIG. 8B. FIG. 6 is a diagram illustrating Example of the backlight 1A of the first embodiment, and illustrating a relationship between chromaticity of emitted light of the LEDs 12 and chromaticity of reflected light of the print pattern 22 when chromaticity of emitted light of the LEDs 12 is adjusted so that chromaticity of emitted light of the LEDs 12 is equal to chromaticity of reflected light of the print pattern 22.

Here, regarding the backlight 1A, how close chromaticity of color of emitted light of the LEDs 12 and chromaticity of reflected color of white ink of the print pattern 22 of the optical sheet 20A should be brought to each other was experimentally examined.

As an experimental condition, as described above, “trade designation: EG-671” manufactured by Teikoku Printing Inks Mfg. Co., Ltd. was used for the white ink of the print pattern 22. Chromaticity of reflected light of this white ink is x=0.3236 and y=0.3264 in chromaticity coordinates of the CIE-XYZ color system. Here, as an illumination light source when chromaticity of reflected light of the white ink “trade designation: EG-671” manufactured by Teikoku Printing Inks Mfg. Co., Ltd. was measured, an achromatic light source (x=0.333 and y=0.333 in the CIE-XYZ color system) was used.

In Example 1, as illustrated in FIG. 6, an adjustment was made so that chromaticity of emitted light of the LEDs 12 matched chromaticity of reflected color of the white ink when an achromatic light source (x=0.333 and y=0.333 in the CIE-XYZ color system) was used as illumination light.

Specifically, for tinge adjustment of white color being emitted light of the LEDs 12, a type and an amount of a phosphor only need to be adjusted, which is generally used. In the market, LEDs 12 of white light are manufactured in various colors depending on usage, from cold color to warm color.

In Example 1, as illustrated in FIG. 6, a color adjustment of the LEDs 12 was made, aiming at color coordinates of the white ink of x=0.324 and y=0.326. As a result, specific chromaticity of emitted light of the LEDs 12 of Example 1 was x=0.324 and y=0.325 in chromaticity coordinates of the CIE-XYZ color system. Δxy, which is defined by a distance between chromaticity coordinates of emitted light of the LEDs 12 and chromaticity coordinates of the white ink after first reflection, was Δxy=0.0130. Note that values were u′=0.207 and v′=0.468 in chromaticity coordinates of the CIE-LUV color system. Similarly, Δu′v′, which is defined by a distance between chromaticity coordinates, was Δu′v′=0.0071.

By contrast, as Comparative Example, general white LEDs for a backlight (product name: NSSW157 manufactured by NICHIA CORPORATION), which are not subjected to tinge adjustment of white color being emitted light of LEDs, were used. Chromaticity of emitted light of white LEDs for a backlight of “product name: NSSW157 manufactured by NICHIA CORPORATION” provided values of x=0.289 and y=0.271 in chromaticity coordinates of the CIE-XYZ color system, and Δxy=0.0132. Note that values were u′=0.204 and v′=0.430 in chromaticity coordinates of the CIE-LUV color system, and Δu′v′=0.0086.

Here, in Example, both chromaticity coordinates of the CIE-XYZ color system and chromaticity coordinates of the CIE-LUV color system are illustrated. When a degree of color difference is considered, it is preferable that chromaticity coordinates of the CIE-LUV color system, in which a color space is more uniform, be used.

Here, Δxy and Δu′v′ represent chromaticity of emitted light of the LEDs 12 and an amount of color shift of the ink after one reflection, respectively. A larger value thereof indicates that there is a larger color change before and after reflection on a white ink surface. Assuming that x and y represent LED chromaticity, and x1 and y1 represent chromaticity of the ink after one reflection, the following equation is obtained.

Δxy=((x−x1)×2+(y−y1)×2)×½

Similarly, assuming that u′ and v′ represent LED chromaticity, and u′1 and v′1 represent chromaticity of the ink after one reflection, the following equation is obtained.

Δu′v′=((u′−u′1)×2+(v′−v′1)×2)×½

Emitted light is reflected by an ink surface a plurality of times before the emitted light reaches positions away from the LEDs 12. Thus, a difference between Example 1 and Comparative Example is not negligible.

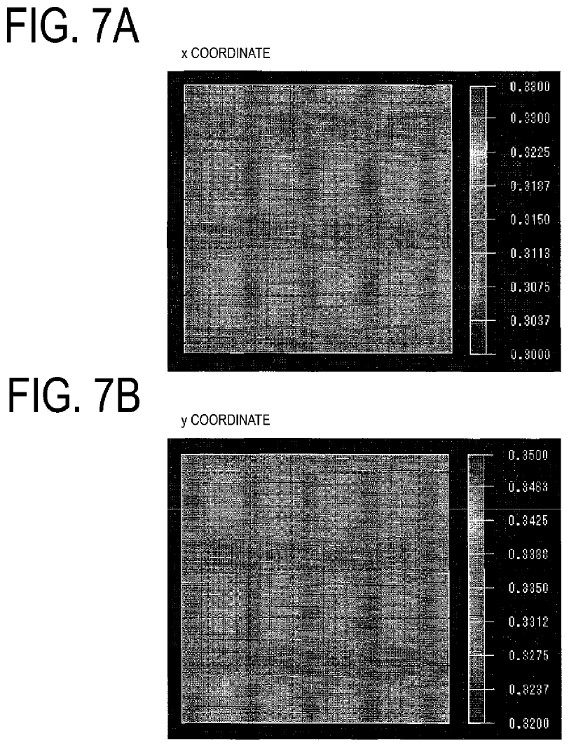

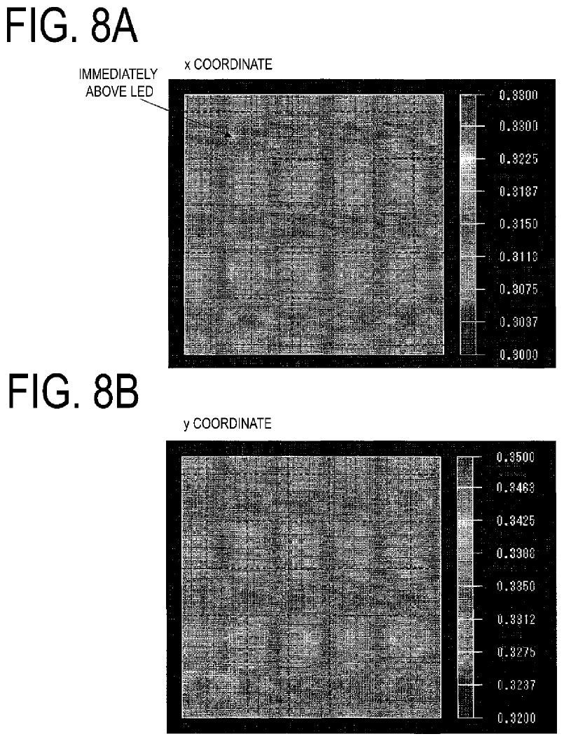

As experimental results, actual assembly into the backlight 1A was carried out, and a degree of color unevenness was observed. Results of the observation are illustrated in FIGS. 7A and 7B and FIGS. 8A and 8B. FIG. 7A is a plan view illustrating the backlight 1A of Example 1, and illustrating a state of color unevenness when an x coordinate of chromaticity of emitted light of the LEDs 12 and an x coordinate of chromaticity of reflected light of the print pattern are brought to be equal to each other. FIG. 7B is a plan view illustrating a state of color unevenness when a y coordinate of chromaticity of emitted light of the LEDs 12 and a y coordinate of chromaticity of reflected light of the print pattern 22 are brought to be equal to each other. FIG. 8A is a plan view illustrating a backlight of Comparative Example, and illustrating a state of color unevenness when an x coordinate of chromaticity of emitted light of light sources and an x coordinate of chromaticity of reflected light of a print pattern are different from each other. FIG. 8B is a plan view illustrating a state of color unevenness when a y coordinate of chromaticity of emitted light of light sources and a y coordinate of chromaticity of reflected light of a print pattern are different from each other.

As illustrated in FIGS. 7A and 7B, in Example 1, it can be understood that there is a small degree of color unevenness. In contrast, in Comparative Example, color unevenness is marked.

As a result, as in Example 1, it was found that when an adjustment is made so that chromaticity of emitted light of the LEDs 12 is equal to chromaticity of reflected light of white ink, a backlight 1A having a small degree of color unevenness can be implemented.

Specifically, it was found that, to bring chromaticity of emitted light of the LEDs 12 equal to chromaticity of reflected light of the print pattern 22, chromaticity of emitted light of the LEDs 12 preferably satisfies values of x=0.324±0.001 and y=0.326±0.001 in the CIE-XYZ color system.

### Supplement

Each of the backlights 1A to 1C of a first aspect of the disclosure is a backlight including a plurality of light sources (LEDs 12) disposed immediately below a display panel and configured to emit white light, and an optical sheet (optical sheets 20A, 20B, diffuser sheet 30) provided on an emitting surface side of the plurality of light sources (LEDs 12) with an air layer 14 interposed between the optical sheet and the plurality of light sources. The optical sheet (optical sheets 20A, 20B, diffuser sheet 30) includes a reflective layer (print pattern 22, white sheet 24, print pattern 32), and chromaticity of emitted light of the plurality of light sources (LEDs 12) and chromaticity of reflected light of the reflective layer (print pattern 22, white sheet 24, print pattern 32) when an achromatic light source (x=0.333 and y=0.333 in a CIE-XYZ color system) is used as illumination light are equal to each other.

According to the above configuration, a backlight includes a plurality of light sources disposed immediately below a display panel and configured to emit white light, and an optical sheet provided on an emitting surface side of the plurality of light sources with an air layer interposed between the optical sheet and the plurality of light sources. Further, the optical sheet includes a reflective layer.

Therefore, in the backlight having the above configuration, a small portion of emitted light from the light sources is transmitted due to the optical sheet, but most of the emitted light is reflected toward the light source side by the reflective layer. The reflected light is reflected by the reflective sheet, and again travels toward the optical sheet. Through repetition of such reflection, light reaches positions other than positions immediately above the light sources, and thus uniformity of luminance can be enhanced.

However, when reflection characteristics of the reflective layer of the optical sheet have wavelength dependency, the color of the reflected light is to be changed according to the number of times of reflection. Specifically, when the reflective layer of the optical sheet has a tinge and is not pure white, the color of the reflected light is to be changed. As a result, color varies between positions immediately above the light sources and positions around the light sources. Consequently, color unevenness is observed.

In view of this, in the backlight of one aspect of the disclosure, chromaticity of emitted light of the plurality of light sources and chromaticity of reflected light of the reflective layer when an achromatic light source (x=0.333 and y=0.333 in a CIE-XYZ color system) is used as illumination light are brought to be equal to each other. Therefore, a hue of the reflected light of the reflective layer is not changed, which prevents color from gradually varying between positions immediately above the light sources and positions around the light sources. As a result, color unevenness is hardly observed.

Therefore, a direct backlight that can prevent color unevenness can be provided.

In the backlights 1A to 1C of a second aspect of the disclosure, the chromaticity of the emitted light of the plurality of light sources (LEDs 12) is preferably adjusted to be equal to the chromaticity of the reflected light of the reflective layer (print pattern 22, white sheet 24, print pattern 32).

In actuality, for example, it may be considered that a print pattern of a white ink is used as the reflective layer. Here, generally, white ink is obtained by dispersing titanium oxide particles as its pigments, and therefore reflection characteristics of white ink are substantially determined. Thus, chromaticity of reflected light of the reflective layer is hardly changed.

In contrast, for adjustment of chromaticity of emitted light of the light sources, a type and an amount of a phosphor only need to be adjusted. Such a type of adjustment is generally used. Therefore, adjustment is easily made. Therefore, change in hues of reflected light of the reflective layer can be reduced, and color unevenness can be reduced.

In the backlights 1A to 1C of a third aspect of the disclosure, each of the chromaticity of the emitted light of the plurality of light sources (LEDs 12) and the chromaticity of the reflected light of the reflective layer (print pattern 22, white sheet 24, print pattern 32) preferably satisfies values of x=0.324±0.001 and y=0.326±0.001 in the CIE-XYZ color system.

In this manner, when chromaticity of the emitted light of the light sources and chromaticity of the reflected light of the reflective layer when an achromatic light source (x=0.333 and y=0.333 in the CIE-XYZ color system) is used as illumination light are set to be equal to each other, the direct backlight 1A that can prevent color unevenness can be provided.

In the backlight 1A of a fourth aspect of the disclosure, the optical sheet 20A may be made of the transparent sheet 21 including the print pattern 22 serving as the reflective layer on a part of a surface of the transparent sheet 21.

With this configuration, when chromaticity of the emitted light of the light sources and chromaticity of the reflected light of the print pattern are brought to be equal to each other, a direct backlight that can prevent color unevenness can be provided.

For example, when the print pattern is disposed in a larger amount at positions immediately above the light sources, there is more reflected light at positions immediately above the light sources. When the print pattern is disposed in a smaller amount at positions away from the light sources, light is transmitted through the transparent sheet. As a result, uniformity of luminance can be enhanced in the entire optical sheet.

In the backlight 1C of a fifth aspect of the disclosure, the optical sheet may be made of the diffuser sheet 30 including the print pattern 32 serving as the reflective layer on a part of a surface of the diffuser sheet 30.

The diffuser sheet is made of a milk-white sheet, diffuses light and allows transmission of light, and is inevitably included in a direct backlight. However, only with the diffuser sheet, luminance immediately above the light sources is excessively increased, and thus luminance unevenness occurs.

In view of this, in the backlight of one aspect of the disclosure, the optical sheet is made of a diffuser sheet including a print pattern serving as the reflective layer on a part of a surface of the diffuser sheet.

With this configuration, when chromaticity of the emitted light of the light sources and chromaticity of the reflected light of the print pattern of the diffuser sheet are brought to be equal to each other, a direct backlight that can prevent color unevenness can be provided.

Instead of an optical sheet being separately provided, a print pattern serving as the reflective layer is provided on a part of a surface of the diffuser sheet inevitably included in a direct backlight. Therefore, a configuration can be simplified. Further, since an optical sheet is not separately provided, a backlight can be thinner.

In the backlight 1B of a sixth aspect of the disclosure, the optical sheet 20B may be made of the white sheet 24 serving as the reflective layer having a plurality of bored openings 23.

With this configuration, when chromaticity of the emitted light of the light sources and chromaticity of the reflected light of the white sheet are brought to be equal to each other, a direct backlight that can prevent color unevenness can be provided.

When the number of openings is reduced at positions immediately above the light sources, emitted light from the light sources is reflected by the white sheet. Further, when the number of openings is increased in an area away from the positions immediately above the light sources, light is transmitted through the openings. As a result, uniformity of luminance can be enhanced in the entire optical sheet.

In the backlight of one aspect of the disclosure, the white sheet serving as the reflective layer is used, and a print pattern is not used. Therefore, burden of forming a print pattern can be omitted.

A manufacturing method of the backlights 1A to 1C of a seventh aspect of the disclosure is a manufacturing method of a backlight including a plurality of light sources (LEDs 12) disposed immediately below a display panel and configured to emit white light and an optical sheet (optical sheets 20A, 20B, diffuser sheet 30) provided on an emitting surface side of the plurality of light sources (LEDs 12) with an air layer 14 interposed between the optical sheet and the plurality of light sources. The manufacturing method includes forming a reflective layer (print pattern 22, white sheet 24, print pattern 32) on the optical sheet (optical sheets 20A, 20B, diffuser sheet 30) and making an adjustment so that chromaticity of emitted light of the plurality of light sources (LEDs 12) is equal to chromaticity of reflected light of the reflective layer (print pattern 22, white sheet 24, print pattern 32) when an achromatic light source (x=0.333 and y=0.333 in a CIE-XYZ color system) is used as illumination light.

With this configuration, chromaticity of the emitted light of the light sources and chromaticity of the reflected light of the reflective layer when an achromatic light source (x=0.333 and y=0.333 in the CIE-XYZ color system) is used as illumination light can be easily brought to be equal to each other. Therefore, a manufacturing method of a direct backlight that can prevent color unevenness can be provided.

Note that the disclosure is not limited to each of the embodiments described above, and various modifications may be made within the scope of the claims. Embodiments obtained by appropriately combining technical approaches disclosed in each of different embodiments also fall within the scope of the technique of the disclosure. Further, novel technical features can be formed by combining the technical approaches disclosed in each of the embodiments.

### REFERENCE SIGNS LIST

### 1A, 1B, 1C Backlight

11 LED substrate

### 12 LED

13 Reflective sheet
14 Air layer
15 Diffuser sheet
16 Prism sheet

### 17 Frame

20A, 20B Optical sheet
21 Transparent sheet
22 Print pattern (reflective layer)

### 23 Opening

24 White sheet (reflective layer)
30 Diffuser sheet (optical sheet)
31 Milk-white sheet
32 Print pattern (reflective layer)

1. A backlight comprising:
a plurality of light sources disposed immediately below a display panel and configured to emit white light; and
an optical sheet provided on an emitting surface side of the plurality of light sources with an air layer interposed between the optical sheet and the plurality of light sources,
wherein the optical sheet includes a reflective layer, and
chromaticity of emitted light of the plurality of light sources and chromaticity of reflected light of the reflective layer when an achromatic light source (x=0.333 and y=0.333 in a CIE-XYZ color system) is used as illumination light are equal to each other.

2. The backlight according to claim 1,
wherein the chromaticity of the emitted light of the plurality of light sources is adjusted to be equal to the chromaticity of the reflected light of the reflective layer.

3. The backlight according to claim 1,
wherein each of the chromaticity of the emitted light of the plurality of light sources and the chromaticity of the reflected light of the reflective layer satisfies values of x=0.324±0.001 and y=0.326±0.001 in the CIE-XYZ color system.

4. The backlight according to claim 1,
wherein the optical sheet is made of a transparent sheet including a print pattern serving as the reflective layer on a part of a surface of the transparent sheet.

5. The backlight according to claim 1,
wherein the optical sheet is made of a diffuser sheet including a print pattern serving as the reflective layer on a part of a surface of the diffuser sheet.

6. The backlight according to claim 1,
wherein the optical sheet is made of a white sheet serving as the reflective layer having a plurality of bored openings.

7. A manufacturing method for manufacturing a backlight, the backlight including a plurality of light sources disposed immediately below a display panel and configured to emit white light, and an optical sheet provided on an emitting surface side of the plurality of light sources with an air layer interposed between the optical sheet and the plurality of light sources, the manufacturing method comprising:
forming a reflective layer on the optical sheet; and
adjusting chromaticity of emitted light of the plurality of light sources to be equal to chromaticity of reflected light of the reflective layer when an achromatic light source (x=0.333 and y=0.333 in a CIE-XYZ color system) is used as illumination light.
